(19) United States
(12) Patent Application Publication
(10) Pub. No.: US 2024/0292372 A1
(43) Pub. Date: Aug. 29, 2024

(54) TERMINAL, BASE STATION, AND WIRELESS COMMUNICATION METHOD

(71) Applicants: DENSO CORPORATION, Kariya-city (JP); TOYOTA JIDOSHA KABUSHIKI KAISHA, Toyota-shi (JP)

(72) Inventors: Tatsuki Nagano, Kariya-city (JP); Hideaki Takahashi, Kariya-city (JP)

(21) Appl. No.: 18/650,266

(22) Filed: Apr. 30, 2024

Related U.S. Application Data
(63) Continuation of application No. PCT/JP2022/040858, filed on Nov. 1, 2022.

(30) Foreign Application Priority Data
Nov. 2, 2021 (JP) 2021-179764

(51) Int. Cl. H04W 68/00

(52) U.S. Cl. CPC H04W 68/005

(57) ABSTRACT

A terminal that includes a reception unit configured to receive first downlink control information (PEI DCI) including information related to paging in one or more paging occasions detected by monitoring a first search space set, and a control unit configured to control monitoring in a second search space set of second downlink control information (paging DCI) including information related to scheduling of a downlink shared channel for transmitting a paging message in the paging occasion and/or information related to a short message based on the first downlink control information in an idle state or an inactive state.

### CROSS-REFERENCE TO RELATED APPLICATION

This application is a continuation application of International Patent Application No. PCT/JP2022/040858, filed Nov. 1, 2022, which designates the U.S. and claims the benefit of priority to Japanese Patent Application No. 2021-179764, filed on Nov. 2, 2021. The entire disclosures of the above applications are incorporated herein by reference.

### TECHNICAL FIELD

The present disclosure relates to a terminal, a base station, and a wireless communication method.

### BACKGROUND

In the Third Generation Partnership Project (3GPP) as an international standards organization, New Radio (NR) Release 15 as the 5th generation (5G) Radio Access Technology (RAT) is specified as a successor to Long Term Evolution (LTE) as the 3.9th generation RAT and LTE-Advanced as the 4th generation RAT, for example, 3GPP TS 38.300 V15.2.0 (2018-06). LTE and/or LTE-Advanced are also called Evolved Universal Terrestrial Radio Access (E-UTRA).

### SUMMARY

In the NR, the terminal is capable of monitoring Downlink Control Information (DCI) (hereinafter, referred to as “paging DCI and also referred to as “second downlink control information) including information related to scheduling of downlink shared channel (for example, Physical Downlink shared channel (PDSCH) for transmitting a paging message and/or information related to a short message in a given period called a Paging Occasion (PO), and receiving the paging message and/or the short message, based on detected paging DCI.

At present, in 3GPP, it is being considered to inform a terminal of information (hereinafter, referred to as “Paging Early Indication (PEI) information”) related to paging in one or more POs, and control a terminal operation in the PO based on the PEI information. In addition, it is also considered to include the PEI information in the DCI transmitted on a downlink control channel (for example, PDCCH).

However, when a DCI including the PEI information (hereinafter, also referred to as “PEI DCI” and also referred to as “first downlink control information” or the like) is newly introduced, there is a concern that a terminal is not capable of appropriately controlling the monitoring of the PEI DCI and/or the paging DCI according to a state of the terminal (for example, an idle state, an inactive state, or a connected state).

One object of the present disclosure is to provide a terminal, a base station, and a wireless communication method capable of appropriately controlling the monitoring of the PEI DCI and/or the paging DCI according to the state of the terminal.

According to one aspect of the present disclosure, there is provided a terminal including a reception unit configured to receive information related to configuration of a search space set configured for monitoring of downlink control information including Paging Early Indication (PEI) information, and a control unit configured to control whether or not to monitor the downlink control information including the PEI information in the search space set configured based on the information related to the configuration, based on whether the terminal is in an idle state, an inactive state, or a connected state.

According to one aspect of the present disclosure, it is possible to appropriately control the monitoring of the PEI DCI and/or the paging DCI according to the state of the terminal.

### BRIEF DESCRIPTION OF DRAWINGS

FIG. 1 is a diagram illustrating an example of a summary of a wireless communication system of the present embodiment.

FIG. 2 is a diagram illustrating an example of a PO of the present embodiment.

FIGS. 3A and 3B are diagrams illustrating examples of DRX control of the present embodiment.

FIG. 4 is a diagram illustrating an example of a relationship between PEI-O and PO of the present embodiment.

FIGS. 5A and 5B are diagrams illustrating examples of a first monitoring control of PEI DCI and paging DCI of the present embodiment.

FIGS. 6A and 6B are diagrams illustrating examples of formats of the PEI DCI and the paging DCI used for the first monitoring control of the present embodiment.

FIGS. 7A and 7B are diagrams illustrating examples of a second monitoring control of the PEI DCI and the paging DCI of the present embodiment.

FIGS. 8A and 8B are diagrams illustrating examples of the formats of the PEI DCI and the paging DCI used for the second monitoring control of the present embodiment.

FIG. 9 is a diagram illustrating an example of reception types according to the first and second monitoring controls of the present embodiment.

FIG. 10 is a diagram illustrating an example of a combination of the reception types for every state of a terminal 10 according to the first monitoring control of the present embodiment.

FIG. 11 is a diagram illustrating an example of a combination of the reception types for every state of the terminal 10 according to the second monitoring control of the present embodiment.

FIG. 12 is a diagram illustrating an example of the number of PDCCH candidates of a PEI search space of the present embodiment.

FIG. 13 is a diagram illustrating an example of a specification change related to configurations of the PEI search space and a paging search space of the present embodiment.

FIG. 14 is a diagram illustrating an example of a hardware configuration of each apparatus in the wireless communication system of the present embodiment.

FIG. 15 is a diagram illustrating an example of a functional block configuration of a terminal of the present embodiment.

FIG. 16 is a diagram illustrating an example of a functional block configuration of a base station of the present embodiment.

### DETAILED DESCRIPTION

Embodiments of the present disclosure will be described with reference to the accompanying drawings. The same or similar configurations in each drawing may be denoted by the same reference numerals.

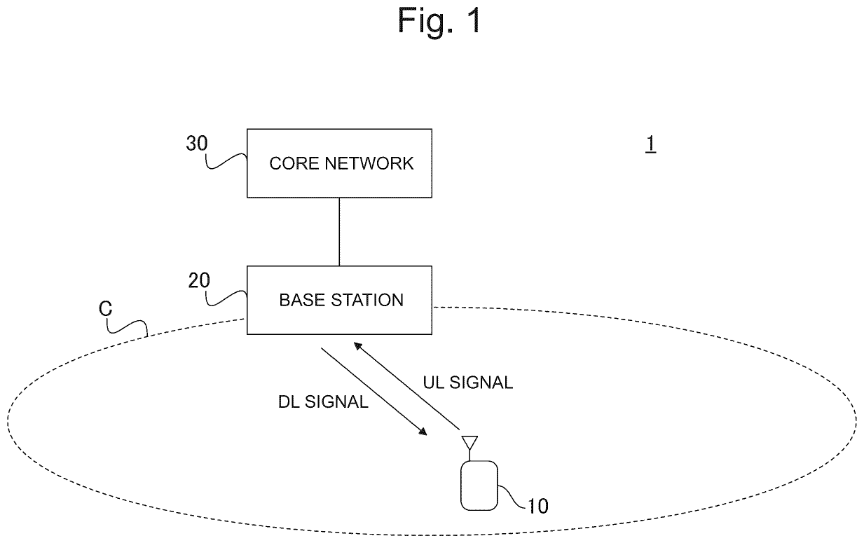

FIG. 1 is a diagram illustrating an example of a summary of a wireless communication system of the present embodiment. As illustrated in FIG. 1, a wireless communication system 1 may include a terminal 10, a base station 20, and a core network 30. The number of terminals 10 and the number of base stations 20 illustrated in FIG. 1 are merely an example and are not limited to the illustrated numbers.

The wireless communication system 1 is a system that performs communication by complying with a Radio Access Technology (RAT) defined by 3GPP. The radio access technology with which the wireless communication system 1 complies is assumed to be, for example, but is not limited to, a fifth generation RAT such as NR. For example, one or more RATs such as a fourth generation RAT such as LTE and LTE-Advanced and a non-3GPP RAT such as an RAT of a sixth generation or later and Wi-Fi (registered trademark) can be used. The wireless communication system 1 may be in the form of performing communication by complying with a radio access technology defined by a standard-setting body (for example, Institute of Electrical and Electronics Engineers (IEEE) and Internet Engineering Task Force (IETF)) different from 3GPP.

The terminal 10 is an apparatus corresponding to a terminal (for example, User Equipment (UE)) defined in the 3GPP specification. The terminal 10 is, for example, a given terminal or apparatus such as a smartphone, a personal computer, a vehicle, a vehicle-mounted terminal, a vehicle-mounted apparatus, a stationary apparatus, a Telematics Control Unit (TCU), and an IoT device such as a sensor. The terminal 10 may be called User Equipment (UE), a Mobile Station (MS), a user terminal, a radio apparatus, a subscriber terminal, an access terminal, or the like. In addition, the terminal 10 may be a so-called reduced capability (RedCap) terminal and may be, for example, an industrial wireless sensor, a video surveillance camera, or a wearable device. The terminal 10 may be of a mobile type or a fixed type. For example, the terminal 10 is configured to be capable of performing communication using one or more RATs such as NR, LTE, LTE-Advanced, and Wi-Fi (registered trademark). The terminal 10 is not limited to a terminal defined in the 3GPP specification and may be a terminal complying with a standard defined by other standard-setting bodies. In addition, the terminal 10 may not be a terminal complying with a standard.

The base station 20 is an apparatus corresponding to a base station (for example, a gNodeB (gNB) or an eNB) defined in the 3GPP specification. The base station 20 forms one or more cells C and communicates with the terminal 10 using the cell. The cell C may be replaced with a serving cell, a carrier, a component carrier (CC), or the like. In addition, the cell C may have a given bandwidth. For example, the base station 20 may communicate with the terminal 10 using one or more cell groups. Each cell group may include one or more cells C. Unifying a plurality of cells C in a cell group is called carrier aggregation. The plurality of cells C may include a primary cell (PCell) or a primary secondary cell group (SCG) cell (PSCell), and one or more secondary cells (SCGs). In addition, communicating with the terminal 10 using two cell groups is called dual connectivity. The terminal 10 is not limited to a base station defined in the 3GPP specification and may be a terminal complying with a standard defined by other standard-setting bodies. In addition, the terminal 10 may not be a base station complying with a standard.

The base station 20 may be called a gNodeB (gNB), an en-gNB, a next generation-radio access network (NG-RAN) node, a low-power node, a central unit (CU), a distributed unit (DU), a gNB-DU, a remote radio head (RRH), an integrated access and backhaul/backhauling (IAB) node, an access point, or the like. The base station 20 is not limited to one node and may be configured with a plurality of nodes (for example, a combination of a lower node such as a DU and a higher node such as a CU).

The core network 30 is, for example, but is not limited to, a fifth generation core network (5G core network (5GC)) or a fourth generation core network (evolved packet core (EPC)). An apparatus on the core network 30 (hereinafter, referred to as a “core network apparatus”) may perform mobility management such as paging and location registration of the terminal 10. The core network apparatus may be connected to the base station 20 or to the terminal 10 through a given interface (for example, an S1 or NG interface).

The core network apparatus may include, for example, at least one of an access and mobility management function (AMF) of managing information on a C plane (for example, information related to access, mobility management, and the like) or a user plane function (UPF) of performing a transmission control of information on a U plane (for example, user data).

In the wireless communication system 1, the terminal 10 receives a downlink (DL) signal from the base station 20 and/or transmits an uplink (UL) signal to the base station 20. In the terminal 10, one or more cells C are configured, and at least one of the configured cells is activated. The maximum bandwidth of each cell is, for example, 20 MHz or 400 MHZ.

In addition, the terminal 10 performs a cell search based on a synchronization signal (for example, a primary synchronization signal (PSS) and/or a secondary synchronization signal (SSS)) from the base station 20. The cell search is a procedure for the terminal 10 to acquire time and frequency synchronization with the cell and detect an identifier (for example, a physical layer cell ID) of the cell.

The terminal 10 determines a search space set and/or a Control Resource Set (CORESET) based on parameters (hereinafter, referred to as “RRC parameters”) included in a Radio Resource Control (RRC) message. The CORESET may be configured with a frequency domain resource (for example, a given number of resource blocks) and a time domain resource (for example, a given number of symbols). The RRC parameters may be called RRC information elements (IEs) or the like.

The terminal 10 monitors downlink control information (DCI) transmitted through a downlink control channel (for example, a physical downlink control channel (PDCCH)) in the search space set associated with the CORESET. The RRC message may include, for example, an RRC setup message, an RRC reconfiguration message, an RRC resume message, an RRC reestablishment message, and system information. Hereinafter, the downlink control channel are referred to as a PDCCH, but may have other names.

Monitoring of the DCI means blind decoding of PDCCH candidates in the search space set with an assumed DCI format by the terminal 10. The number of bits (referred to as a size, a bit width, or the like) of the DCI format is set in advance or derived in accordance with the number of bits of fields included in the DCI format. The terminal 10 detects the DCI for the terminal 10 based on the number of bits of the DCI format and on a specific Radio Network Temporary Identifier (RNTI) used for scrambling a Cyclic Redundancy Check (CRC) bit (referred to as a CRC parity bit) of the DCI format (hereinafter, referred to as “CRC scrambling”). Monitoring of the DCI is called PDCCH monitoring, a PDCCH monitor, or the like. In addition, a given period for monitoring the DCI or the PDCCH is called a PDCCH monitoring occasion.

The terminal 10 receives (or detects) the DCI which is CRC scrambled using the specific RNTI (for example, P-RNTI, Cell (C)-RNTI, or the like) by monitoring the PDCCH using the search space set in the PDCCH monitoring occasion. The terminal 10 controls reception of a downlink shared channel (for example, a physical downlink shared channel (PDSCH)) scheduled using the DCI and/or transmission of an uplink shared channel (for example, a physical uplink shared channel (PUSCH)) scheduled using the DCI. Hereinafter, the downlink shared channel and the uplink shared channel are referred to as PDSCH and PUSCH, but may have other names.

The search space set is a set of one or more search spaces and may include a search space set (hereinafter, referred to as a “common search space (CSS) set”) to be used in common between one or more terminals 10 and a terminal-specific search space set (UE-specific search space (USS) set). The terminal 10 receives information related to the configuration of each search space set, and configures each search space set based on the information related to the configuration.

For example, the terminal 10 may receive information (hereinafter, referred to as “paging search space configuration information”, for example, RRC parameter “pagingSearchSpace”) related to the configuration of the search space set for paging (hereinafter, referred to as “paging search space”), and may configure a paging search space (for example, Type2-PDCCH CSS set) based on the information. The terminal 10 may detect a DCI which is CRC scrambled using a specific RNTI (for example, a paging (P)-RNTI).

The terminal 10 receives a paging message through the PDSCH scheduled using the DCI. Here, the information indicating the P-RNTI may be configured by a predefined value. Hereinafter, the DCI which is CRC scrambled using the P-RNTI is referred to as a “paging DCI”. The format of the DCI may be, for example, a DCI format 1_0. Further, the terminal 10 may receive a short message based on the paging DCI.

The system information broadcasted by the cell C may include a master information block (MIB) and/or one or more system information blocks (SIBs). The MIB is broadcasted through a broadcast channel (for example, a physical broadcast channel (PBCH)). The MIB and an SIB1 are called minimum system information, and the SIB1 is called remaining minimum system information (RMSI). An SIBx (x is any character string such as x=2, 3, . . . ) other than the SIB1 is called other system information (OSI). The SIB1 and the SIBx other than the SIB1 are broadcasted through the PDSCH. The SIB1 may be cell-specific, and the SIBx other than the SIB1 may be cell-specific or specific to an area including one or more cells.

A block including at least one of the synchronization signal, the PBCH, and a PBCH Demodulation Reference signal (DM-RS) is called a Synchronization Signal Block (SSB). The SSB may be called an SS/PBCH block, an SS block, or the like. The SSB may be configured with a given number of symbols (for example, four consecutive symbols) as the time domain resource and a given number of subcarriers (for example, 240 consecutive subcarriers) as the frequency domain resource.

An SS burst set which is a set of one or more SSBs is transmitted at a given periodicity. The SS burst set may be called an SS burst or the like. Each SSB in the SS burst set is identified by an index (hereinafter, referred to as an “SSB index”). In the case of multi-beam operation, SSBs having different indexes in the SS burst set correspond to different beams and may be transmitted by sequentially switching a beam direction via beam sweeping. In the case of single-beam operation, an SSB (one or more SSBs) having a specific index in the SS burst set may be transmitted in all directions.

One or more bandwidth parts (BWPs) may be configured for one cell C. The BWP may include a BWP for the DL (hereinafter, referred to as a “DL BWP”) and/or a BWP for the UL (hereinafter, referred to as a “UL BWP”). In addition, the BWP may include a BWP (hereinafter, referred to as an “initial BWP”) configured to be cell-specific and a BWP (hereinafter, referred to as a “dedicated BWP”) configured to be specific to the terminal 10. The initial BWP may be used for initial access and/or be common to one or more terminals 10. The initial BWP may include an initial BWP for the DL (hereinafter, referred to as an “initial DL BWP”) and an initial BWP for the UL (hereinafter, referred to as an “initial UL BWP”). The dedicated BWP is called a “UE-specific BWP”.

### Paging

Paging is used for setting up a network-led connection when the terminal 10 is in an idle state or an inactive state. In addition, paging is used for transmission of a short message. The short message may be used for an indication to modify system information and/or a public warning system (PWS). In addition, the short message may be informed regardless of the state of the terminal 10. The PWS is, for example, an Earthquake and Tsunami Warning System (ETWS), a Commercial Mobile Alert System (CMAS), or the like. The state of the terminal 10 may be, for example, the state of the RRC such as an idle state, an inactive state, or a connected state.

Here, the idle state is a state in which RRC layer connection (hereinafter, referred to as “RRC connection”) between the terminal 10 and the base station 20 is not established, and is called RRC_IDLE, an idle mode, an RRC-idle mode, or the like. The terminal 10 in the idle state receives the system information broadcasted in a camp-on cell. When the RRC connection is established, the terminal 10 in the idle state transitions to the connected state.

In addition, the inactive state is a state where the RRC connection is established but is suspended and is also called an RRC_INACTIVE state, an inactive mode, an RRC inactive mode, and the like. The terminal 10 in the inactive state receives the system information broadcasted in the camp-on cell. When the RRC connection is resumed, the terminal 10 in the inactive state transitions to the connected state, and when the RRC connection is released, the terminal 10 transitions to the idle state.

The connected state is a state where the RRC connection is established and is also called an RRC_CONNECTED state, a connected mode, an RRC connected mode, and the like. When the RRC connection is released, the terminal 10 in the connected state transitions to the idle state, and when the RRC connection is suspended, the terminal 10 transitions to the inactive state.

The terminal 10 performs Discontinuous Reception (DRX) to reduce power consumption. Specifically, the terminal 10 is capable of performing PDCCH monitoring in a Paging Occasion (PO) and sleeping in a period other than the PO.

The PO is a given period configured with one or more time units (for example, one or more symbols, one or more slots, or one or more subframes). The PO may be configured with, for example, a set of one or more PDCCH monitoring occasions. The PO may be provided at a given periodicity. The PO may be provided in a Paging Frame (PF). A Radio Frame (RF) configuring the PF is a given time unit (for example, a time unit configured with 10 subframes), and is identified by an identification number (hereinafter, referred to as a “System Frame Number (SFN)”). One or more PFs may be provided in a DRX periodicity. The DRX periodicity is also called a paging cycle.

In the terminal 10, information (hereinafter, referred to as “PCCH-Config”) related to the configuration of paging in the BWP may be configured by the base station 20. PCCH-Config may include at least one of information (hereinafter, referred to as “PagingCycle”) related to the DRX periodicity, information (hereinafter, referred to as “firstPDCCH-MonitoringOccasionOfPO”) related to a first PDCCH-monitoring occasion of the PO, information (hereinafter, referred to as “nAndPagingFrameOffset”) indicating the number of PFs in the paging cycle and/or a time offset, information (hereinafter, referred to as “ns”) related to the number of POs per PF, and information (hereinafter, referred to as “nrofPDCCH-MonitoringOccasionPerSSB-InPO”) related to the number of PDCCH monitoring occasions per SSB in the PO. The PCCH-Config may be a cell-specific RRC parameter.

The terminal 10 determines the PF for the terminal 10 based on at least one of a DRX periodicity, the number of PFs in the DRX periodicity, the time offset, or an identifier of the terminal 10. Here, for example, the terminal 10 may determine the SFN constituting the PF based on the following Formula 1.

$$( SFN + PF\_offset ) mod T = ( T div N ) * ( UE\_ID mod N ) \qquad Formula 1$$

Here, T is the DRX periodicity determined based on the PagingCycle, N and PF_offset are the number of PFs in T and a given offset determined based on the nAndPagingFrameOffset, and UE_ID is a value determined based on the identifier of the terminal 10 (for example, 5G S-Temporary Mobile Subscription Identifier (5G-S-TMSI)). PagingCycle may indicate, for example, 32, 64, 128, or 256 RFs. nAndPagingFrameOffset may indicate positioning of the PF for every x RFs in T (for example, x=1, 2, 4, 8, or 16) and/or the time offset.

The terminal 10 may determine the PO in the PF based on at least one of an ID of the search space used as the paging search space, firstPDCCH-MonitoringOccasionOfPO described above, or nrofPDCCH-MonitoringOccasionPerSSB-InPO described above. The PO may be configured with, for example, S*X consecutive PDCCH monitoring occasions (for example, S*X consecutive symbols excluding an UL symbol) from a time location indicated by firstPDCCH-MonitoringOccasionOfPO. Each PDCCH monitoring occasion in the PO may be configured with a given number of symbols. The firstPDCCH-MonitoringOccasionOfPO may indicate, for example, the time location (for example, the location of the symbol) of the first PDCCH monitoring occasion in the PF. S may be the number of SSBs actually transmitted in the SS burst set, and X may be the number of PDCCH monitoring occasions per SSB in the PO.

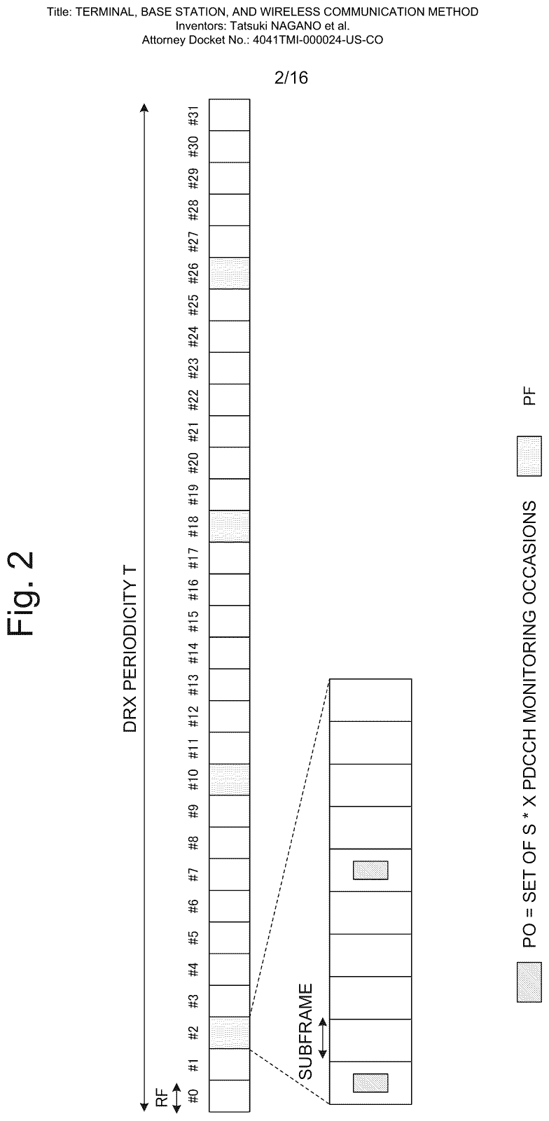

FIG. 2 is a diagram illustrating an example of the PO of the present embodiment. As illustrated in FIG. 2, the PF is disposed every given number of RFs (here, 8 RFs) in the DRX periodicity (here, 32 RFs). The terminal 10 may determine the PF (here, PF #2) for the terminal 10 using, for example, Expression 1, based on UE_ID. For example, in FIG. 2, the number of POs included in PF #2 for the terminal 10 is two, but is not limited thereto, and the number of POs per PF may be one or more.

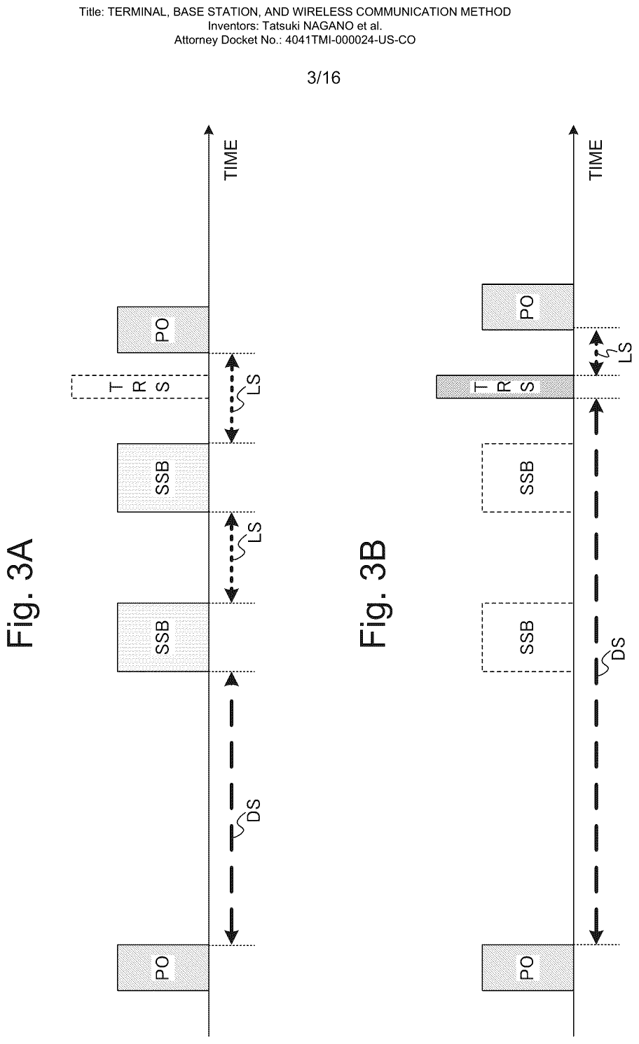

FIGS. 3A and 3B are diagrams illustrating examples of DRX control of the present embodiment. The terminal 10 is in an on-state for every PO, and is in a sleep state except for a given period except for the PO. Specifically, the terminal 10 may be in the sleep state except for a period for time and frequency synchronization with the cell other than the PO. For example, one or more SSBs and/or a reference signal for tracking (hereinafter, referred to as “Tracking Reference Signal (TRS)”) is used for the time and frequency synchronization.

For example, as illustrated in FIG. 3A, the terminal 10 may acquire the time and frequency synchronization with the cell using one or more SSBs before the PO. In FIG. 3A, the sleep state of the terminal 10 between the previous PO and the first SSB is Deep Sleep (DS), but the sleep state between the first SSB to the next PO may be Light Sleep (LS) having a smaller power consumption reducing effect than the DS. Alternatively, as illustrated in FIG. 3B, the terminal 10 may acquire the time and frequency synchronization with the cell using the TRS disposed in the time location closer to a next PO than the SSB. In FIG. 3B, the terminal 10 is capable of maintaining the DS for a longer period than in FIG. 3A, and thus, it is possible to reduce the power consumption compared to FIG. 3A.

The terminal 10 monitors the paging search space in the PO based on the time and frequency synchronization using the SSB and/or the TRS. The terminal 10 may receive the paging message through the PDSCH scheduled by the paging DCI detected by monitoring the paging search space. Further, the terminal 10 may receive a short message based on the paging DCI.

TRS may be paraphrased as a Channel State Information-Reference Signal (CSI-RS), a Non Zero Power-CSI-RS (NZP-CSI-RS), a TRS/CSI-RS, or the like. A resource for the TRS (hereinafter, “TRS resource”) may be configured with, for example, a set (hereinafter, “NZP-CSI-RS resource set”) of one or more resources for NZP-CSI-RS (hereinafter, referred to as “NZP-CSI-RS resource”). The TRS resource may be configured with a given number of symbols and a given number of subcarriers in a given periodicity.

In addition, the terminal 10 may receive information (hereinafter, referred to as “TRS availability information”) related to the transmission of the TRS in the TRS resource, and may determine whether or not to perform the time and frequency synchronization using the TRS based on the TRS availability information. The TRS availability information may indicate, for example, whether or not the TRS is actually transmitted in the TRS resource.

The terminal 10 controls establishment of connection with a network side (for example, the CN 30 and/or the base station 20) based on a list (for example, RRC parameter “pagingRecordList”) of one or more terminal identifiers in the paging message received in the PO and a terminal identifier assigned to the terminal 10. For example, when the terminal identifier assigned to the terminal 10 is included in the list, the terminal 10 may start a procedure for establishing the connection with the network side. Here, the terminal identifier is the identifier of the terminal 10 and may be determined based on, for example, 5G-S-TMSI.

According to the above Expression (1), a plurality of terminals 10 may be assigned to the same PO. On the other hand, even when the terminal 10 receives the paging DCI, it is not possible to discriminate which terminal 10 the paging is directed to unless the list of terminal identifiers in the paging message is decoded. Therefore, there is a concern that, among the plurality of terminals 10 that share the same PO, the terminal 10 that is not the paging target in the PO unnecessarily perform time and frequency synchronization and PDCCH monitoring in the PO. As a result, there is a concern that the power consumption of the terminal 10 that is not the paging target may be wasted in the PO.

### Subgrouping

In order to reduce wasted power consumption of the terminal 10 that is not the paging target, instead of performing paging for every group configured with a plurality of terminals 10 which use the same PO, it is also being considered to classify the plurality of terminals 10 as a plurality of subgroups and to perform paging for every subgroup. The subgrouping may be performed on a terminal identifier base or may be performed on a network base.

In a case of the terminal identifier base, the terminal 10 may determine a subgroup assigned to the terminal 10 based on the terminal identifier. Specifically, the terminal 10 may determine an identifier of the subgroup (hereinafter, referred to as “subgroup ID”) based on at least one of the number N of PFs in the DRX periodicity T, the number Ns of POs per PF, and the total number Nsg of subgroups in addition to the terminal identifier.

On the other hand, in the network base, the base station 20 or the core network apparatus may determine a subgroup to be assigned to the terminal 10 based on information managed on the network side (for example, a mobility state of the terminal 10, a paging probability and/or a power consumption profile of the terminal 10, or the like). An apparatus on the network side may inform the terminal 10 of the information indicating the determined subgroup (for example, a subgroup ID).

### PEI DCI

At present, in 3GPP, it is being considered to inform the PEI information related to the paging in one or more POs to the terminal 10 and to control a terminal operation in the PO based on the PEI information. In addition, it is also being considered to include the PEI information in the DCI transmitted by the PDCCH.

The PEI information may include, for example, information related to subgroups that are the paging targets in the PO (hereinafter, referred to as “subgroup information”). The subgroup information may be, for example, information (for example, a 1-bit value) indicating whether or not paging is performed for every subgroup (that is, whether paging is performed for every subgroup or every group).

In addition, the PEI information may include information indicating which subgroup is the paging target in one or more POs (hereinafter, referred to as “paging subgroup indication information”). One or more POs may be included in a single PF, or may be included in a plurality of PFs. For example, the PEI may correspond to a maximum of 4 POs in 1 PF.

For example, the terminal 10 that shares each PO is divided into a given number of subgroups (for example, a maximum of 8 subgroups), and the paging subgroup indication information may indicate whether or not each subgroup is the paging target (presence or absence of the paging message for each subgroup) in each PO. The paging subgroup indication information may be, for example, a bitmap of the number of bits corresponding to the number of subgroups of one or more POs, or information indicating an identifier of a subgroup that is the paging target in each PO.

In addition to the PEI information, the PEI DCI may include information (hereinafter, referred to as “short message information”) related to a short message and/or the TRS availability information.

The terminal 10 may determine the time location of the PDCCH monitoring occasion for PEI DCI (hereinafter, referred to as “PEI-O”) based on a PO (hereinafter, referred to as “target PO”) indicating which subgroup is the paging target by the PEI DCI detected in the PEI-O. For example, the time location of the PEI-O may be determined based on a time offset (for example, a time offset at a frame level) with respect to the PF including the target PO. Alternatively, the time location of PEI-O may be determined based on the SSB or the SS burst before the target PO. The SS burst may be, for example, a L-th (for example, L=1, 2 or 3) SS burst before the first PDCCH monitoring occasion before the PO. Alternatively, the time location of the PEI-O may be determined based on a time offset with respect to the target PO.

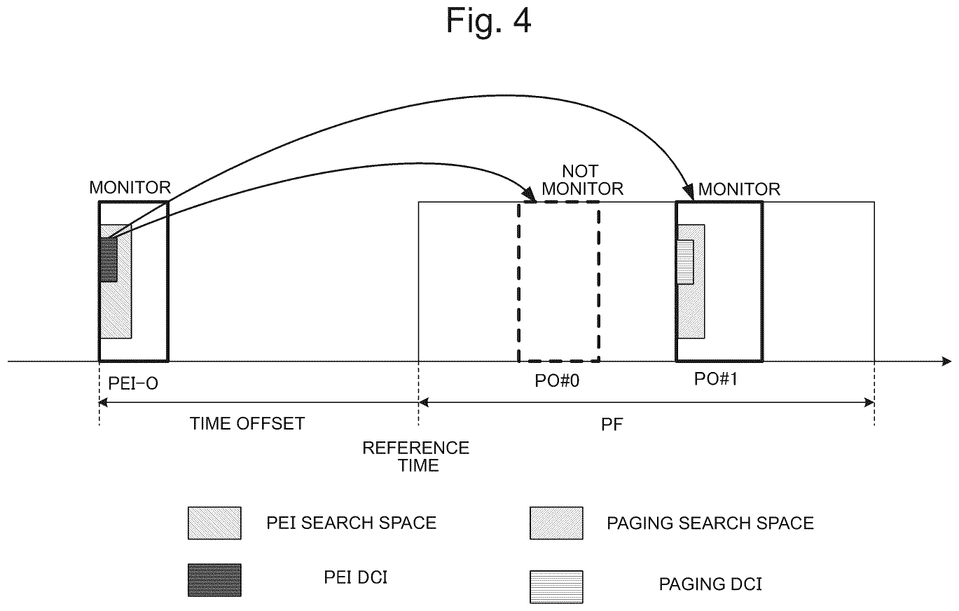

FIG. 4 is a diagram illustrating an example of the relationship between the PEI-O and the PO of the present embodiment. As illustrated in FIG. 4, the PEI-O may be provided with a search space set (hereinafter, referred to as “PEI search space”) used for monitoring the PEI DCI. The PEI DCI detected by monitoring the PEI search space may correspond to one or more POs (for example, a maximum of 4 POs per 1 PF). One PEI DCI may correspond to a plurality of POs straddling a plurality of PFs, or may correspond to one or more POs in a single PF. In addition, a plurality of PEI DCIs may correspond to one PO.

For example, in FIG. 4, the start timing of the PEI-O is determined by using the start timing of the PF including POs #0 and #1 as the reference time and a time offset with respect to the reference time (for example, a time offset at an RF level). In addition, as described above, the start timing of the PEI-O is not limited to the start timing illustrated in FIG. 4, and may be determined based on the SSB or the SS burst before the PO or may be determined based on the first PO. In addition, a plurality of POs corresponding to one PEI may straddle a plurality of PFs.

In FIG. 4, the terminal 10 in an idle state or an inactive state detects the PEI DCI by monitoring the PEI search space. The terminal 10 skips the monitoring of the paging search space in PO #0 based on the paging subgroup indication information in the PEI DCI. Since the terminal 10 maintains the sleep state in PO #0, it is possible to reduce the power consumption. On the other hand, the terminal 10 monitors the paging DCI in the paging search space in the PO #1 based on the paging subgroup indication information in the PEI DCI.

As described above, when the terminal 10 is in the idle state or the inactive state, the monitoring of the paging DCI in one or more POs is controlled based on the PEI DCI detected by the monitoring of the PEI search space, so that it is possible to reduce the power consumption of the terminal 10. On the other hand, in the connected state, the terminal 10 assumes that it is not necessary to monitor the PEI DCI. Since paging for the terminal 10 in the connected state is not performed, it is not necessary to recognize whether or not the terminal 10 is the paging target in the PO by the PEI DCI. In addition, in the connected state, how the terminal 10 receives the short message also becomes a problem.

As described above, when the PEI DCI is newly introduced, it is desired that the terminal 10 appropriately control the monitoring of the PEI DCI in the PEI-O and/or the monitoring of the paging DCI in the PO according to the state of the terminal 10 (for example, the idle state, the inactive state, or the connected state).

Therefore, in the present embodiment, the monitoring control of the PEI DCI and/or the paging DCI will be described. For example, the terminal 10 monitors the PEI DCI in the idle state or the inactive state but the terminal 10 may not monitor the PEI DCI in the connected state (first monitoring control). Alternatively, the terminal 10 of the present embodiment monitors the PEI DCI in the idle state or the inactive state and the terminal 10 may also monitor the PEI DCI in the connected state (second monitoring control).

In the present embodiment, the monitoring of the PEI DCI may mean the blind decoding of a specific DCI format (for example, DCI format 1_X (for example,X=any character string such as 0, 1, 2, . . . )) in which the PEI search space (for example, Type2A-PDCCH CSS set) is CRC scrambled using a first RNTI (for example, PEI-RNTI). The information indicating the first RNTI may be configured by a predefined value, or may be transmitted from the base station 20 to the terminal 10 to be configured in the terminal 10.

In addition, the monitoring of the paging DCI may be blind decoding of a specific DCI format (for example, DCI format 1_0) in which the paging search space (for example, Type2-PDCCH CSS set) is CRC scrambled using a second RNTI (for example, P-RNTI). The information indicating the second RNTI may be configured by a predefined value.

Hereinafter, it will be described as assuming that the first RNTI (hereinafter, referred to as “PEI-RNTI”) used for CRC scrambling of the PEI DCI and the second RNTI (hereinafter, referred to as “P-RNTI”) used for the CRC scrambling of the paging DCI are different RNTIs. Hereinafter, the first RNTI and the second RNTI will be referred to as the PEI-RNTI and the P-RNTI, respectively, but the names are not limited thereto.

In addition, hereinafter, the PEI DCI and the paging DCI are same size DCI formats, and the PEI DCI and the paging DCI are distinguished by the PEI-RNTI and the P-RNTI, but the present invention is not limited thereto. For example, it is possible to appropriately apply the present embodiment even when the PEI DCI and the paging DCI are different size DCI formats. When the PEI DCI and the paging DCI are different size DCI formats, both the DCIs may be CRC scrambled with the same RNTI (for example, P-RNTI).

### First Monitoring Control

In the first monitoring control, the terminal 10 receives PEI DCI (first downlink control information) including the PEI information related to paging in one or more POs detected by monitoring the PEI search space (first search space set).

When the terminal 10 is in the idle state or the inactive state, the terminal 10 controls monitoring in the paging search space (second search space set) of the paging DCI (second downlink control information) including information (hereinafter, referred to as scheduling information) related to scheduling of the PDSCH (downlink shared channel) for transmitting the paging message and/or the short message information in the PO, based on the PEI DCI.

On the other hand, in the connected state, the terminal 10 monitors the paging DCI including the short message information in the paging search space without monitoring the PEI DCI in the PEI search space.

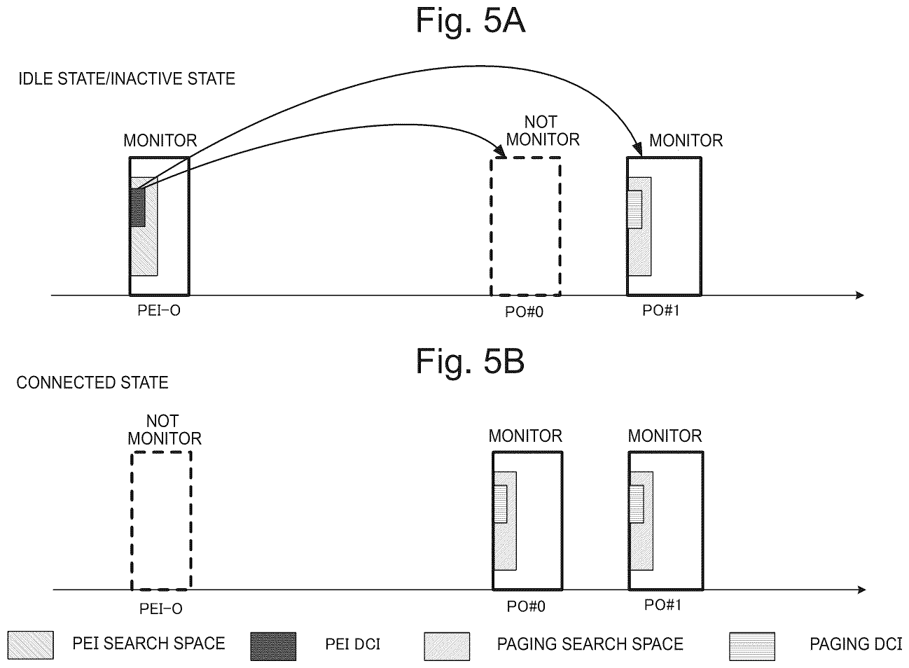

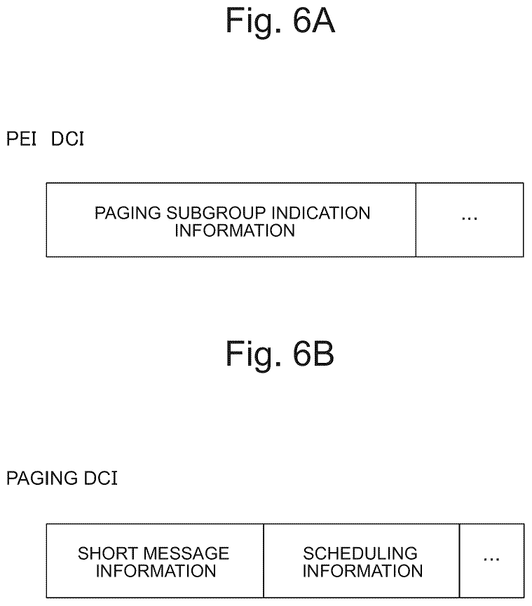

FIGS. 5A and 5B are diagrams illustrating examples of the first monitoring control of the PEI DCI and the paging DCI of the present embodiment. FIGS. 6A and 6B are diagrams illustrating examples of the formats of the PEI DCI and the paging DCI used for the first monitoring control of the present embodiment. FIGS. 5A and 5B will be described mainly on the differences from FIG. 4. In addition, the formats illustrated in FIGS. 6A and 6B are merely examples, and may include fields (not illustrated), some fields may be omitted.

FIG. 5A illustrates an example of the first monitoring control by the terminal 10 in the idle state or the inactive state. As illustrated in FIG. 5A, when the terminal 10 is in the idle state or the inactive state, the terminal 10 monitors the PEI DCI in the PEI search space in the PEI-O, and detects the PEI DCI. As illustrated in FIG. 6A, the PEI DCI may include, for example, paging subgroup indication information indicating paging target subgroups of the target POs #0 and #1. In addition, the PEI DCI may include the subgroup information and/or the TRS availability information and/or the short message information.

In FIG. 5A, as will be described later, since the paging DCI includes the short message information, the PEI DCI may not include the short message information. For example, regardless of whether the terminal 10 that supports the PEI DCI is in the idle state, the inactive state, or the connected state, the terminal 10 may receive the short message based on the short message information in the paging DCI. In this case, the PEI DCI may not include the short message information.

Otherwise, in FIG. 5A, both the paging DCI and the PEI DCI may include the short message information. For example, when the terminal 10 that supports the PEI DCI is in the idle state or the inactive state in which the PEI DCI monitoring is performed, the terminal 10 receives the short message based on the short message information in the PEI DCI, and, when the terminal 10 is in the connected state in which the PEI DCI monitoring is not performed, the terminal 10 may receive the short message based on the short message information in the paging DCI. In this case, the PEI DCI may include the short message information.

Since FIG. 5A illustrates that the subgroup which belongs to the terminal 10 in the target PO #0 is not the paging target using the paging subgroup indication information in the PEI DCI, the terminal 10 does not monitor the paging DCI in the PO #0. On the other hand, since the paging subgroup indication information indicates that the subgroup which belongs to the terminal 10 in the target PO #1 is the paging target, the terminal 10 monitors the paging DCI in the paging search space of the PO #1.

As illustrated in FIG. 6B, the paging DCI detected in the paging search space of the PO #1 includes the scheduling information of the PDSCH for transmitting the paging message. The scheduling information may be, for example, information related to a frequency domain resource and/or a time domain resource assigned to the PDSCH. The terminal 10 in the idle state or the inactive state may receive the paging message via the PDSCH based on the scheduling information in the paging DCI.

In addition, as illustrated in FIG. 6B, the paging DCI detected in the paging search space of the PO #1 may include the short message information. The terminal 10 in the idle state or the inactive state may receive the short message (for example, the indication to modify the system information or at least one of ETWS and CMAS) based on the short message information in the paging DCI.

FIG. 5B illustrates an example of the first monitoring control by the terminal 10 in the connected state. As illustrated in FIG. 5B, when the terminal 10 is in the connected state, the terminal 10 does not monitor the PEI DCI in the PEI search space in the PEI-O.

In FIG. 5B, the terminal 10 in the connected state monitors the paging DCI in the paging search space of each of the PO #0 and the PO #1. As illustrated in FIG. 6B, the paging DCI detected by the monitoring may include the short message information. The terminal 10 may receive the short message (for example, the indication to modify the system information or at least one of ETWS and CMAS) based on the short message information in the paging DCI. On the other hand, the terminal 10 in the connected state may skip receiving the paging message based on the scheduling information in the paging DCI.

For example, the terminal 10 in the connected state may monitor the paging DCI in order to acquire the short message related to the modification of the system information in at least one PO in the modification period of the system information. In addition, the terminal 10 in the connected state may monitor the paging DCI in order to acquire the short message related to inform the PWS (for example, at least one of ETWS and CMAS) in at least one PO in a given periodicity (for example, a DRX periodicity or a paging cycle).

According to the first monitoring control, when the terminal 10 is in the idle state or the inactive state, the monitoring of the paging search space in one or more POs is controlled based on the PEI DCI detected by the monitoring of the PEI search space, so that it is possible to reduce the power consumption of the terminal 10. In addition, when the terminal 10 is in the connected state, the terminal 10 receives the short message based on the paging DCI in the same manner as the terminal 10 which does not support the PEI DCI. Therefore, it is possible to reduce the design loads accompanying with the defining of the new operation for the terminal 10 in the connected state.

### Second Monitoring Control

In the first monitoring control described above, when the terminal 10 is in the connected state, the PEI DCI is not monitored in the PEI search space. However, in the second monitoring control, when the terminal 10 is in a connected state, the PEI DCI including the short message information is monitored in the PEI search space, thereby being different from the first monitoring control. The second monitoring control will be described mainly on the differences from the first monitoring control.

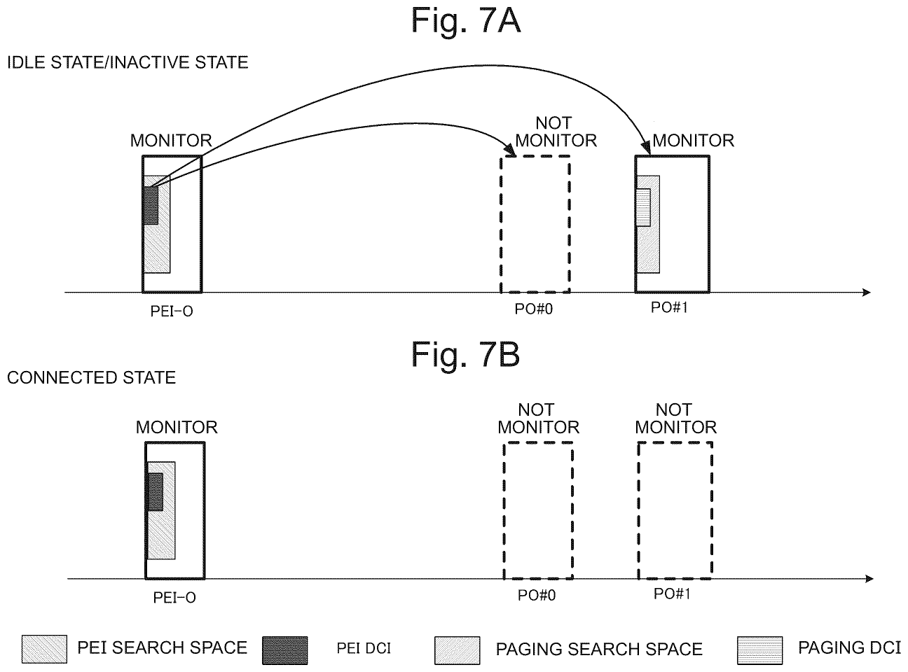

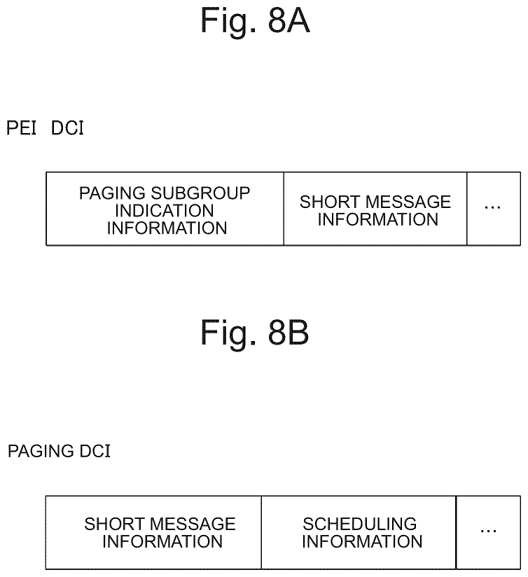

FIGS. 7A and 7B are diagrams illustrating examples of the second monitoring control of the PEI DCI and the paging DCI of the present embodiment. FIGS. 8A and 8B are diagrams illustrating examples of the formats of the PEI DCI and the paging DCI used for the second monitoring control of the present embodiment. FIGS. 7A and 7B will be described mainly on the differences from FIG. 4 and FIGS. 5A and 5B. In addition, the formats illustrated in FIGS. 8A and 8B are merely examples, and may include fields (not illustrated), and some fields may be omitted.

FIG. 7A illustrates an example of the second monitoring control by the terminal 10 in the idle state or the inactive state. As illustrated in FIG. 7A, when the terminal 10 is in the idle state or the inactive state, the terminal 10 monitors the PEI DCI in the PEI search space in the PEI-O, and detects the PEI DCI. As illustrated in FIG. 8A, the PEI DCI may include, for example, paging subgroup indication information indicating subgroups of paging targets of the target POs #0 and #1. In addition, the PEI DCI may include the above-described subgroup information and/or the TRS availability information (not illustrated).

The PEI DCI illustrated in FIG. 8A may include the short message information. In FIG. 7A, the terminal 10 in the idle state or the inactive state may receive the short message (for example, the indication to modify the system information or at least one of ETWS and CMAS) based on the short message information in the PEI DCI.

In FIG. 7A, the terminal 10 in the idle state or the inactive state does not monitor the paging DCI in the PO #0, and monitors the paging DCI in the paging search space of the PO #1. As illustrated in FIG. 8B, the paging DCI detected in the paging search space of the PO #1 includes the scheduling information of the PDSCH for transmitting the paging message. The terminal 10 in the idle state or the inactive state may receive the paging message via the PDSCH based on the scheduling information in the paging DCI. When the terminal 10 does not support the PEI DCI (for example, when the terminal 10 is before release 16), the terminal 10 receives the short message based on the short message information in the paging DCI, and thus the paging DCI of FIG. 8B may include the short message information.

FIG. 7B illustrates an example of the second monitoring control by the terminal 10 in the connected state. As illustrated in FIG. 7B, when the terminal 10 is in the connected state, the terminal 10 monitors the PEI DCI including the short message information in the PEI search space in the PEI-O.

The terminal 10 may receive the short message (for example, the indication to modify the system information or at least one of ETWS and CMAS) based on the short message information in the PEI DCI detected by the monitoring. For example, the terminal 10 in the connected state may monitor the PEI DCI in order to acquire the short message related to the modification of the system information in at least one PEI-O in the modification period of the system information. In addition, the terminal 10 in the connected state may monitor the PEI DCI in order to acquire the short message related to inform the PWS (for example, at least one of ETWS and CMAS) in at least one PEI-O in a given periodicity (for example, a DRX periodicity or a paging cycle).

In addition, when the PEI DCI including the short message information is not detected by monitoring the PEI search space in the PEI-O, the terminal 10 may assume that the short message is not transmitted.

According to the second monitoring control, regardless of whether the terminal 10 is in the idle state, the inactive state, or the connected state, the terminal 10 is capable of acquiring the short message based on the short message information in the PEI DCI detected by monitoring the PEI search space. Therefore, as in the first monitoring control, in order to acquire the short message, the monitoring of the paging DCI may not be performed in the paging search space of the PO.

Specification change example related to first and second monitoring controls

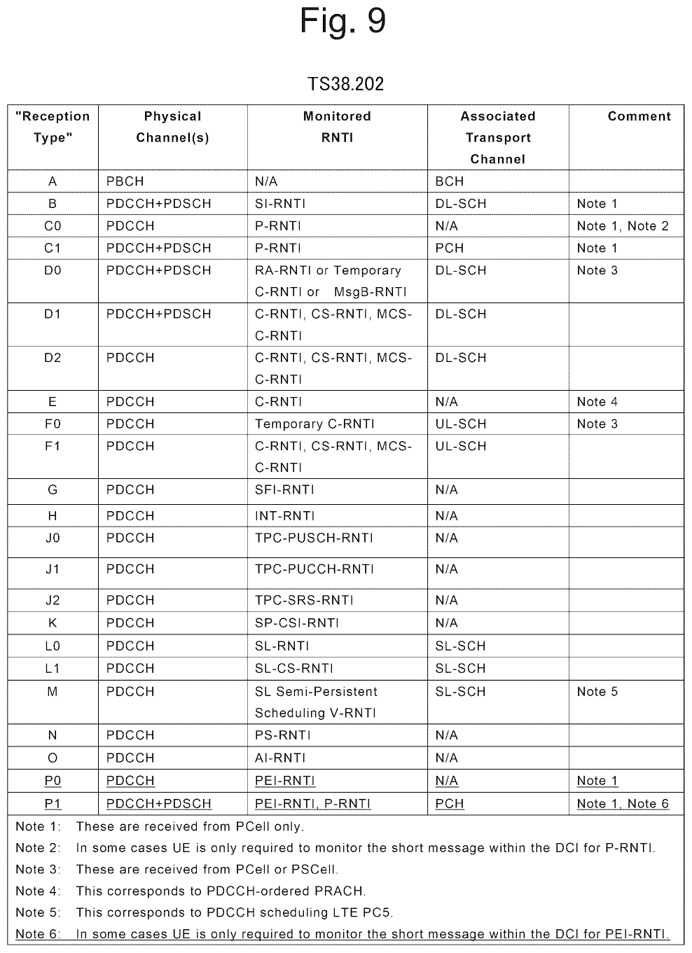

A specification change example in the 3GPP specification related to the first and second monitoring controls will be described with reference to FIGS. 9 to 11. The following specification change example is merely an example, and the specification change examples related to the first and second monitoring controls of the present embodiment are not limited to those described below.

FIG. 9 is a diagram illustrating an example of reception types according to the first and second monitoring controls of the present embodiment. In FIG. 9, the RNTI monitored by the terminal 10 is associated with a physical channel and a transport channel, which are related to the DCI which is CRC scrambled by the RNTI. The association between the RNTI and the physical channel and the transport channel is identified by the reception type.

For example, a reception type “P0” indicates that the DCI (that is, PEI DCI) which is CRC scrambled by the PEI RNTI is transmitted via the PDCCH only in the Primary Cell (PCell). In addition, a reception type “P1” indicates that the DCI (that is, PEI DCI) which is CRC scrambled by the PEI RNTI and the DCI (that is, the paging DCI) which is CRC scrambled by the P-RNTI are transmitted via the PDCCH only in the PCell, the PDSCH is scheduled by the paging DCI, and the PDSCH is associated with the transport channel “Paging Channel (PCH)”. Similarly, another reception type associate the physical channel and the monitored RNTI or associates the physical channel, a monitored RNTI, and a transport channel.

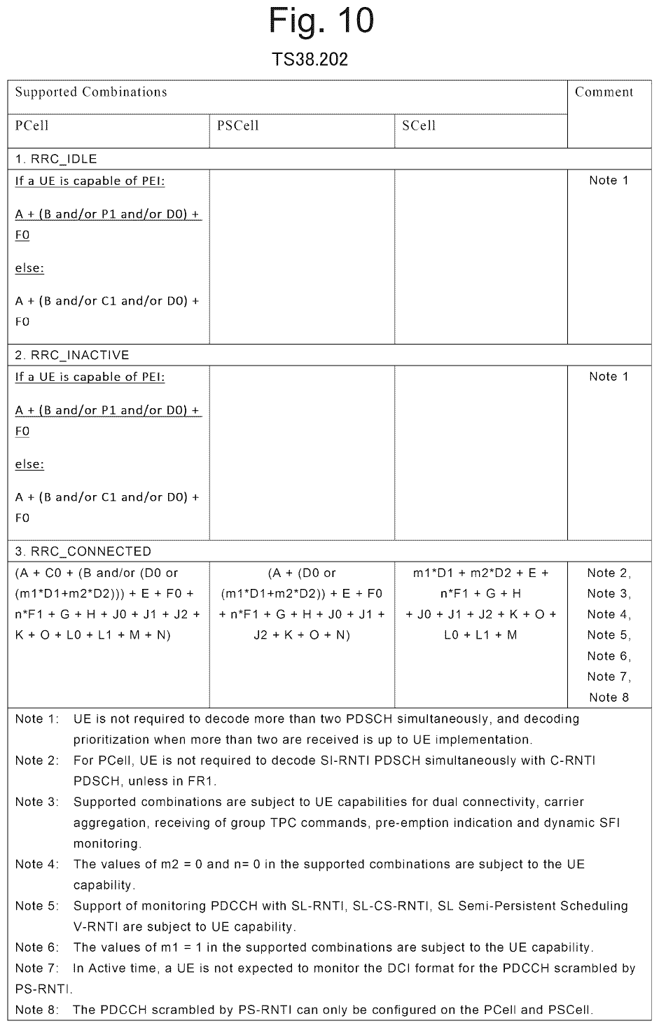

FIG. 10 is a diagram illustrating an example of a combination of the reception types for every state of the terminal 10 according to the first monitoring control of the present embodiment. For example, in FIG. 10, when the terminal 10 is in the idle state (RRC_IDLE) or the inactive state (RRC_INACTIVE) and the terminal 10 supports the PEI DCI, the terminal 10 may receive the physical channel and/or the corresponding transport channel according to a combination of the reception types “A+(B and/or P1 and/or D0)+F0” in FIG. 9. On the other hand, when the terminal 10 does not support the PEI DCI, “C1” may be applied instead of the reception type “P1”.

When the terminal 10 is in the connected state (RRC_CONNECTED), as illustrated in FIG. 10, the reception type in which the terminal 10 uses to receive the physical channel and/or the corresponding transport channel does not include “P0” and “P1”. Therefore, the terminal 10 in the connected state does not monitor the DCI (that is, the PEI DCI) which is CRC scrambled by the PEI-RNTI.

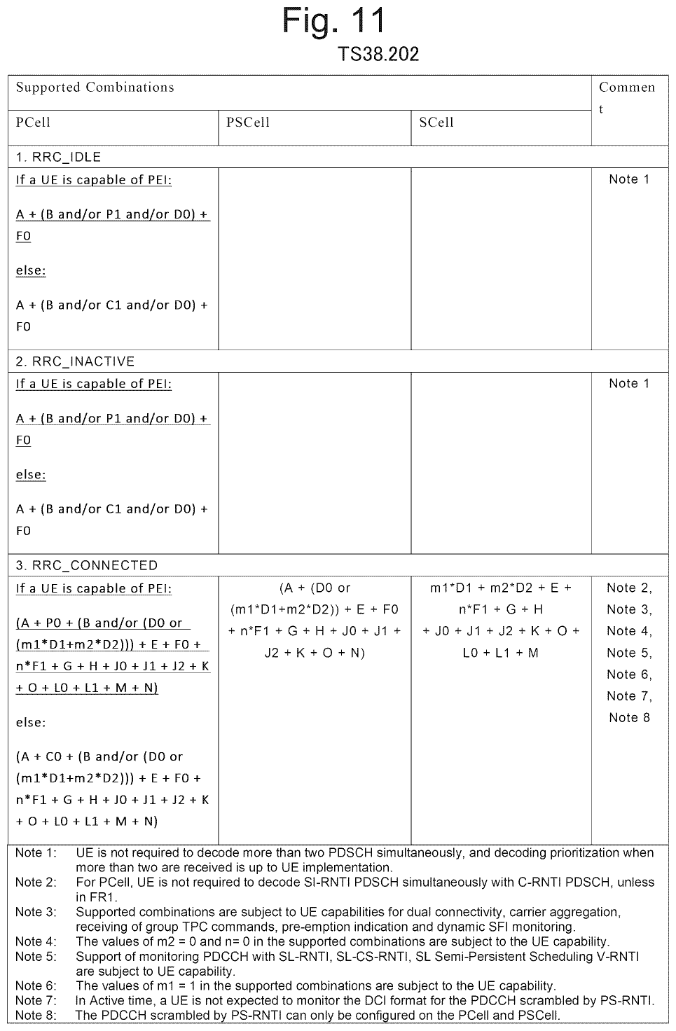

FIG. 11 is a diagram illustrating an example of a combination of the reception types for every state of the terminal 10 according to the second monitoring control of the present embodiment. For example, in FIG. 11, when the terminal 10 is in the idle state (RRC_IDLE) or the inactive state (RRC_INACTIVE), the terminal 10 operates in the same manner as in FIG. 10.

When the terminal 10 is in the connected state (RRC_CONNECTED) and the terminal 10 supports the PEI DCI, the terminal 10 may receive the physical channel and/or the corresponding transport channel according to a combination of reception types “A+P0+(B and/or (D0 or (m1*D1 and m2*D2)))+E+F0+n*F1+G+H+J0+J1+J2+K+O+L0+L1+M+N” in FIG. 9. The terminal 10 in the connected state may receive a short message in the PEI DCI by monitoring the DCI (that is, PEI DCI) which is CRC scrambled by the PEI-RNTI using the reception type “P0”. When the terminal 10 does not support the PEI DCI, “C0” may be applied instead of the reception type “P0”.

### Configuration of PEI Search Space

The terminal 10 may receive information related to configuration of the PEI search space (hereinafter, referred to as “PEI search space information”) and configure the PEI search space based on the PEI search space configuration information. The PEI search space may be called, for example, a Type2A-PDCCH CSS set or the like.

The PEI search space configuration information is, for example, an RRC parameter, may be included in information related to configuration of the PDCCH (hereinafter, “PDCCH configuration information”), or may be included in the system information. The PDCCH configuration information may be, for example, the RRC parameter “pdcch-ConfigCommon” related to the configuration of the cell-specific PDCCH (PDCCH in the initial DL BWP), or the RRC parameter “pdcch-Config” related to the configuration of the terminal 10-specific PDCCH.

The PEI search space configuration information may include, for example, at least one of an identifier (for example, RRC parameter “searchSpaceId”) of the search space used as the PEI search space, an identifier (for example, RRC parameter “controlResourceSetId”) of CORESET associated with the PEI search space, information (for example, RRC parameter “duration”) related to PEI-O period, information (for example, RRC parameter “monitoringSymbolsWithinSlot”) related to the first symbol which performs PDCCH monitoring in the slot, information (for example, RRC parameter “monitoringSlotPeriodicityAndOffset”) related to the periodicity and/or offset of the PEI-O), and the like.

When the PEI search space configuration information is not given to the terminal 10 from the base station 20, the terminal 10 may not monitor the PEI DCI in the PEI search space.

The number of PDCCH candidates configuring the PEI search space may be determined in the specifications, or may be configured in the terminal 10 by the base station 20. For example, information related to the number of PDCCH candidates may be included in the PEI search space configuration information. In addition, the number of PDCCH candidates configuring the PEI search space may be determined or configured for every Aggregation Level (AL). The AL is the number of integrations of Control Channel Elements (CCE) that configure one PDCCH candidate. In a case of ALX (for example, X=1, 2, 4, 8, 16, 32, and the like), one PDCCH candidate is configured with X CCEs.

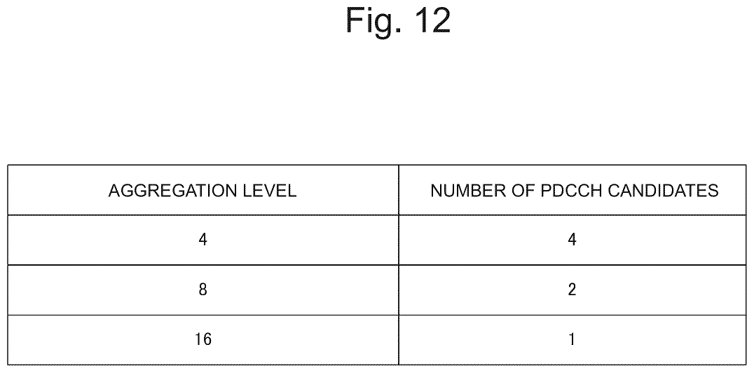

FIG. 12 is a diagram illustrating an example of the number of PDCCH candidates of the PEI search space of the present embodiment. For example, in FIG. 12, the PEI search space is configured with 7 PDCCH candidates including 4 PDCCH candidates of AL4, 2 PDCCH candidates of AL8, and 1 PDCCH candidate of AL16. The number of PDCCH candidates for every AL illustrated in FIG. 12 is predetermined in the specifications and may be applied not only to the PEI search space but also to the paging search space. As described above, the number of PDCCH candidates for every AL configuring the PEI search space may be the same as or different from the number of PDCCH candidates for every AL configuring the paging search space.

The terminal 10 may not assume the processing of information from the plurality of DCI formats which are CRC scrambled using a specific RNTI per slot. That is, the terminal 10 may assume a single DCI format which is CRC scrambled using the specific RNTI per slot. For example, the terminal 10 may assume that the DCI which is CRC scrambled using the PEI-RNTI is a PEI DCI (that is, a single DCI format for the PEI DCI).

Specification change example related to configuration of PEI search space

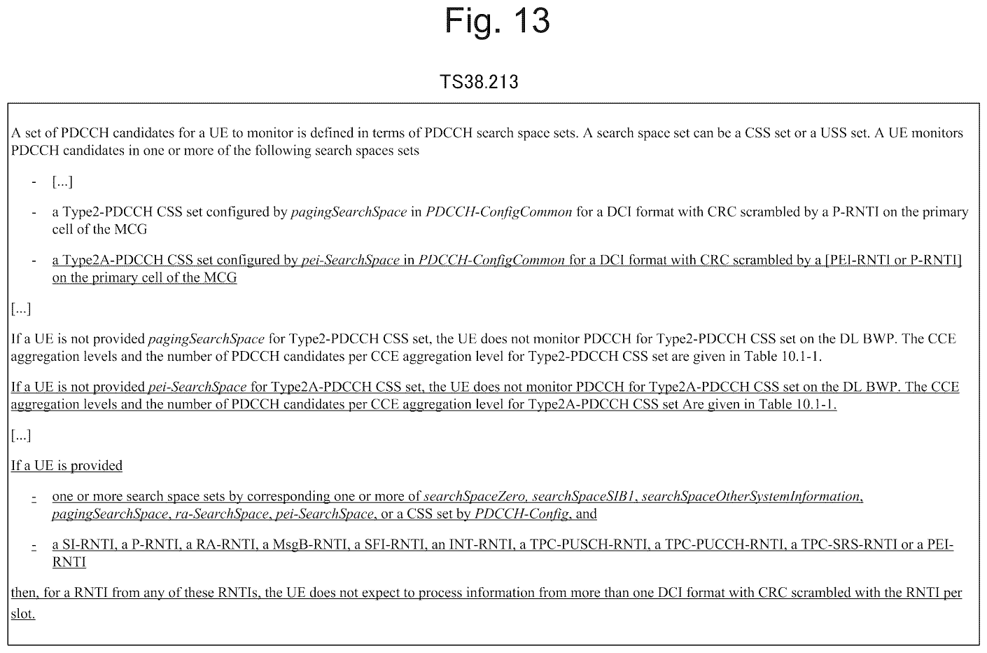

A specification change example in the 3GPP specification related to the configuration of the PEI search space and the paging search space will be described with reference to FIG. 13. The following specification change example is merely an example, and the specification change example related to the configuration of the PEI search space and the paging search space of the present embodiment is not limited to those described below.

As illustrated in FIG. 13, the terminal 10 may monitor the paging search space (for example, Type2-PDCCH CSS set) configured using the paging search space configuration information (for example, RRC parameter “pagingSearchSpace”) for the DCI format (that is, paging DCI) which is CRC scrambled by the P-RNTI in a primary cell of a Master Cell Group (MCG).

The terminal 10 may monitor the PEI search space (for example, Type2A-PDCCH CSS set) configured using the PEI search space configuration information (for example, RRC parameter “pei-SearchSpace”) for the DCI format (that is, PEI DCI) which is CRC scrambled by the PEI-RNTI or the P-RNTI in the primary cell of the MCG.

When the PEI search space configuration information (for example, RRC parameter “pei-SearchSpace”) for the PEI search space (for example, Type2A-PDCCH CSS set) is not given to the terminal 10, the terminal 10 may not monitor the PDCCH for the PEI search space in the DL BWP. The aggregation level for the PEI search space and the number of PDCCH candidates per aggregation level may be given in a table illustrated in FIG. 12.

When a set of one or more search space sets and one or more RNTIs are given to the terminal 10, the terminal 10 may assume that a DCI format to be CRC scrambled by any RNTI per slot is a single DCI format. The set of one or more search space sets includes, for example, the search space #0, a search space for SIB1 in the initial DL BWP of the PCell, a search space for another system information, a paging search space, a search space for random access, a PEI search space, or a CSS set.

The above-described search space #0 may be configured in the terminal 10 based on the RRC parameter “searchSpaceZero”. The search space for the SIB1 may be configured in the terminal 10 based on the RRC parameter “searchSpaceSIB1”. The paging search space may be configured in the terminal 10 based on the RRC parameter “pagingSearchSpace”. The search space for random access may be configured in the terminal 10 based on the RRC parameter “ra-SearchSpace”. The PEI search space may be configured in the terminal 10 based on the RRC parameter “pei-SearchSpace”.

In addition, the one or more RNTIs described above may be System Information (SI)-RNTI, P-RNTI, Random Access (RA)-RNTI, Message B (MsgB)-RNTI, Slot Format Indication (SFI)-RNTI, Interruption (INT)-RNTI, Transmit Power Control-Sounding Reference Signal (TPC-SRS)-RNTI, TPC-PUSCH-RNTI, TPC-PUCCH-RNTI, or PEI-RNTI.

### Configuration of Wireless Communication System

Next, a configuration of each apparatus of the wireless communication system 1 described above will be described. The following configuration illustrates a necessary configuration in describing the present embodiment and does not exclude each apparatus including a functional block other than the illustrated functional blocks.

### Hardware Configuration

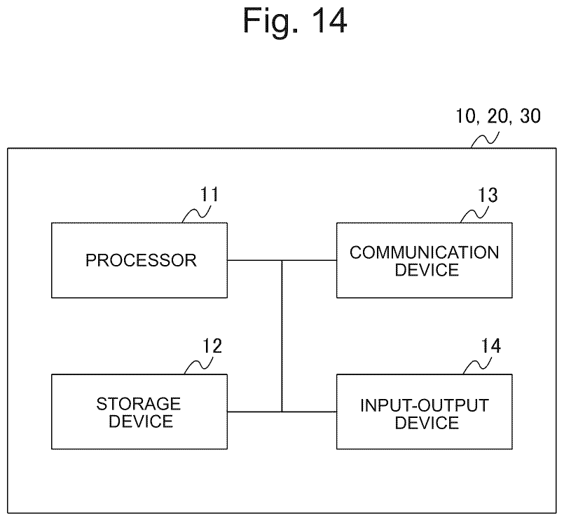

FIG. 14 is a diagram illustrating an example of a hardware configuration of each apparatus in the wireless communication system of the present embodiment. Each apparatus (for example, the terminal 10, the base station 20, and the CN 30) in the wireless communication system 1 includes a processor 11, a storage device 12, a communication device 13 that performs wired or wireless communication, and an input device that receives various input operations or an input-output device 14 that outputs various types of information.

The processor 11 is, for example, a central processing unit (CPU) and controls each apparatus in the wireless communication system 1. The processor 11 may perform various types of processing described in the present embodiment by reading out a program from the storage device 12 and performing the program. Each apparatus in the wireless communication system 1 may be configured with one or more processors 11. In addition, each apparatus may be called a computer.

The storage device 12, for example, is configured with a storage such as a memory, a hard disk drive (HDD), and/or a solid state drive (SSD). The storage device 12 may store various types of information (for example, the program performed by the processor 11) necessary for performing the processing via the processor 11.

The communication device 13 is a device that performs communication through a wired and/or wireless network and may include, for example, a network card, a communication module, a chip, or an antenna. In addition, the communication device 13 may include a radio frequency (RF) device that performs processing related to an amplifier and to a radio signal and a baseband (BB) device that performs baseband signal processing.

The RF device generates a radio signal to be transmitted from the antenna by performing, for example, D/A conversion, modulation, frequency conversion, and power amplification with respect to a digital baseband signal received from the BB device. In addition, the RF device generates a digital baseband signal by performing frequency conversion, demodulation, A/D conversion, and the like with respect to a radio signal received from the antenna and transmits the digital baseband signal to the BB device.

The BB device performs processing of converting data into a digital baseband signal. Specifically, the BB device may generate an OFDM symbol by mapping the data to a subcarrier and performing an IFFT and generate the digital baseband signal by inserting a CP into the generated OFDM symbol. The BB device may apply a transform precoder (DFT spreading) before mapping the data to the subcarrier.

In addition, the BB device performs processing of converting a digital baseband signal into data. Specifically, the BB device may remove the CP from the digital baseband signal input from the RF device and extract a signal of the frequency domain by performing an FFT with respect to the signal in which the CP is removed. The BB device may apply an IDFT to the signal of the frequency domain.

The input-output device 14, for example, includes an input device such as a keyboard, a touch panel, a mouse, and/or a microphone and, for example, includes an output device such as a display and/or a speaker.

The hardware configuration described above is merely an example. Each apparatus in the wireless communication system 1 may be partially omitted in the hardware described in FIG. 14 or may include hardware not described in FIG. 14. In addition, the hardware illustrated in FIG. 14 may be configured with one or more chips.

### Functional Block Configuration

### Terminal

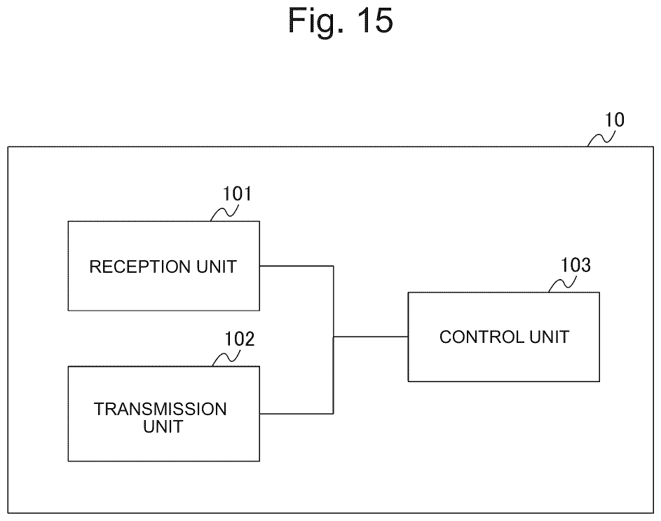

FIG. 15 is a diagram illustrating an example of a functional configuration of the terminal of the present embodiment. As illustrated in FIG. 15, the terminal 10 includes a reception unit 101, a transmission unit 102, and a control unit 103. The functional configuration illustrated in FIG. 15 is merely an example. Any functional distinction and any names of functional units with which the operation of the present embodiment can be performed may be used. In addition, the reception unit 101 and the transmission unit 102 may be collectively referred to as a communication unit.

All or a part of the functions implemented by the reception unit 101 and by the transmission unit 102 can be implemented using the communication device 13. In addition, all or a part of the functions implemented by the reception unit 101 and by the transmission unit 102 and the control unit 103 can be implemented by performing the program stored in the storage device 12 via the processor 11. In addition, it is possible to store the program in a storage medium. The storage medium in which the program is stored may be a non-transitory computer readable medium. The non-transitory storage medium is not particularly limited and, for example, may be a storage medium such as a USB memory or a CD-ROM.

The reception unit 101 receives a signal (for example, the DL signal and/or a sidelink signal). In addition, the reception unit 101 may receive information and/or data transmitted through the signal. Here, the term “receive”, for example, may include performing processing related to reception such as at least one of reception of a radio signal, demapping, demodulation, decoding, monitoring, or measurement. The DL signal may include at least one of, for example, the PDSCH, the PDCCH, a downlink reference signal, the synchronization signal, or the PBCH.

The reception unit 101 detects the DCI by monitoring the PDCCH candidates in the search space. The reception unit 101 may receive DL data through the PDSCH scheduled using the DCI. The DL data may include downlink user data and/or control information of a higher layer (for example, parameters of at least one of the MAC layer, an RRC layer, and the Non Access Stratum (NAS) layer). The reception unit 101 may receive the system information through the PBCH and/or the PDSCH.

The transmission unit 102 transmits a signal (for example, the UL signal and/or the sidelink signal). In addition, the transmission unit 102 may transmit information and/or data transmitted through the signal. Here, the term “transmit”, for example, may include performing processing related to transmission such as at least one of encoding, modulation, mapping, or transmission of a radio signal. The UL signal may include at least one of, for example, the PUSCH, the PRACH, the PUCCH, or an uplink reference signal.

The transmission unit 102 may transmit UL data through the PUSCH scheduled using the DCI received by the reception unit 101. Uplink user data and/or control information of a higher layer (for example, parameters of at least one of the MAC layer, the RRC layer, or the NAS layer) may be transmitted in the UL data.

The control unit 103 performs various controls in the terminal 10. Specifically, the control unit 103 may control the operation of the terminal 10 based on information (for example, the parameters of the RRC layer) related to various types of configuration received by the reception unit 101 from the base station 20 or from other terminals 10. Operating the terminal 10 based on the information may be synonymous with “configuring the configuration information in the terminal 10”.

The control unit 103 may control reception of the signal in the reception unit 101. In addition, the control unit 103 may control transmission of the signal in the transmission unit 102. The control unit 103 may determine whether to apply the transform precoder to the signal transmitted by the transmission unit 102.

In the present embodiment, the terminal 10 may include a reception unit 101 that receives first downlink control information (for example, PEI DCI) including information related to paging in one or more paging occasions detected by monitoring a first search space set (for example, PEI search space), and a control unit 103 that controls monitoring in a second search space set (for example, paging search space) of the second downlink control information (for example, paging DCI) including information related to scheduling of a downlink shared channel for transmitting a paging message in the paging occasion and/or information related to a short message, based on the first downlink control information in an idle state or in an inactive state.

In a case of the connected state, the control unit 103 may not monitor the first downlink control information in the first search space set, and may monitor the second downlink control information including the information related to the short message in the second search space set.

In a case of the connected state, the control unit 103 may monitor the first downlink control information including the information related to the short message in the first search space set. The information related to the short message may include an indication to modify system information and/or information related to a public warning system.

The reception unit 101 may receive information related to configuration of the first search space set (for example, PEI search space configuration information). The control unit 103 may monitor the first downlink control information in the first search space set configured based on the information related to the configuration. When the information related to the configuration is not received by the reception unit 101, the control unit 103 may not monitor the first downlink control information in the first search space set.

The reception unit 101 may receive information related to configuration of the second search space set (for example, paging search space configuration information). The control unit 103 may monitor the second downlink control information in the second search space set configured based on the information related to the configuration. When the information related to the configuration is not received by the reception unit 101, the control unit 103 may not monitor the second downlink control information in the second search space set.

A Cyclic Redundancy Check (CRC) bit is added to the first downlink control information by a first Radio Network Temporary Identifier (RNTI) (for example, PEI-RNTI), and a CRC bit scrambled by the second RNTI (for example, P-RNTI) is added to the second downlink control information. The control unit 103 may assume that the downlink control information, to which the CRC bit scrambled by the first RNTI is added, is the first downlink control information.

### Base Station

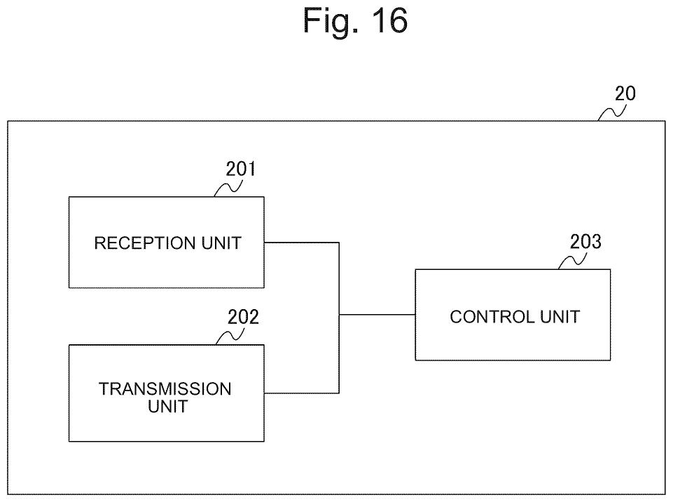

FIG. 16 is a diagram illustrating an example of a functional block configuration of the base station of the present embodiment. As illustrated in FIG. 16, the base station 20 includes a reception unit 201, a transmission unit 202, and the control unit 203. The functional configuration illustrated in FIG. 16 is merely an example. Any functional distinction and any names of functional units with which the operation of the present embodiment can be performed may be used. In addition, the reception unit 201 and the transmission unit 202 may be collectively referred to as a communication unit.

All or a part of the functions implemented by the reception unit 201 and by the transmission unit 202 can be implemented using the communication device 13. In addition, all or a part of the functions implemented by the reception unit 201 and by the transmission unit 202 and the control unit 203 can be implemented by performing the program stored in the storage device 12 via the processor 11. In addition, it is possible to store the program in a storage medium. The storage medium in which the program is stored may be a non-transitory computer readable medium. The non-transitory storage medium is not particularly limited and, for example, may be a storage medium such as a USB memory or a CD-ROM.

The reception unit 201 receives a signal (for example, the UL signal and/or the sidelink signal). In addition, the reception unit 201 may receive information and/or data (for example, the UL data) transmitted through the signal.

The transmission unit 202 transmits a signal (for example, the DL signal and/or the sidelink signal). In addition, the transmission unit 202 may transmit information and/or data (for example, the DL data) transmitted through the signal. A part of the information transmitted from the transmission unit 202 may be transmitted by a transmission unit in the core network apparatus.

The control unit 203 performs various controls for communicating with the terminal 10. Specifically, the control unit 203 may determine information related to various types of configuration of which the terminal 10 is informed. Transmitting the information to the terminal 10 may be synonymous with “configuring the information in the terminal”.

The control unit 203 may control reception of the signal in the reception unit 201. In addition, the control unit 203 may control transmission of the signal in the transmission unit 202.

In the present embodiment, the base station 20 may include a transmission unit 202 that transmits first downlink control information (for example, PEI DCI) including the information related to paging in one or more paging occasions in a first search space set (for example, PEI search space), and a control unit 203 that controls transmission of second downlink control information (for example, paging DCI) including information related to scheduling of a downlink shared channel for transmitting a paging message in the paging occasion and/or information related to a short message based on the information related to the paging.

The transmission unit 202 may transmit information (for example, PEI search space configuration information) related to the configuration of the first search space set. The transmission unit 202 may transmit the first downlink control information in the first search space set configured based on the information related to the configuration.

The transmission unit 202 may transmit information (for example, paging search space configuration information) related to the configuration of the second search space set. The transmission unit 202 may transmit the second downlink control information in the second search space set configured based on the information related to the configuration.

### Supplement

Various signals, information, and parameters in the embodiment may be signaled in any layer. That is, the various signals, information, and parameters may be replaced with signals, information, and parameters of any layer such as a higher layer (for example, the NAS layer, the RRC layer, and the MAC layer) and a lower layer (for example, the physical layer). In addition, informing an apparatus of given information is not limited to explicit informing and may be implicitly performed (for example, without informing the apparatus of information or using other types of information).

In addition, names of various signals, information, parameters, IEs, channels, time units, and frequency units in the embodiment are merely an example and may be replaced with other names. For example, a slot may have any name of a time unit having a given number of symbols. In addition, an RB may have any name of a frequency unit having a given number of subcarriers. In addition, the terms “first” and “second” are simply for identifying a plurality of pieces of information or signals and may be reversed in order, as appropriate.

For example, in the embodiment, each of the PDSCH, the PUSCH, the PDCCH, the PBCH, the PRACH, and the like has been illustrated in the present embodiment as examples of a physical channel for transmitting the DL data, a physical channel for transmitting the UL data, a physical channel for transmitting the DCI, a physical channel for transmitting broadcast information, and a physical channel for transmitting the RA preamble. However, the physical channels are not limited to the illustrated names as long as the physical channels have the same functions. In addition, these physical channels may be replaced with transport channels to which the physical channels are mapped. In addition, each of the PDSCH, the PUSCH, the PDCCH, the PBCH, the PRACH, and the like may be replaced with a transport channel (for example, at least one of a downlink shared channel (DL-SCH), an uplink shared channel (UL-SCH), a broadcast channel (BCH), or a random access channel (RCH)) and the like mapped to a physical channel. In addition, these transport channels may be replaced with logical channels to which the transport channels are mapped. In addition, the DL data and the UL data may be downlink data and uplink data, respectively, and the data may include user data and control information of a higher layer (for example, the RRC parameters and the medium access control (MAC) parameters).

In addition, the terminal 10 in the embodiment is not limited to the illustrated purposes (for example, RedCap and IoT) and may be used for any purposes (for example, eMBB, URLLC, device-to-device (D2D), and vehicle-to-everything (V2X)) as long as the terminal 10 has the same functions. In addition, forms of various types of information are not limited to the embodiment and may be changed to a bit representation (0 or 1), a truth value (Boolean; true or false), an integer value, a text, and the like, as appropriate. In addition, singular forms and plural forms in the embodiment may be changed from each other.

The embodiment described above is for easy understanding of the present disclosure and is not to be interpreted as limiting the present disclosure. The flowcharts, sequences, each element in the embodiment and positioning of the elements, indexes, conditions, and the like described in the embodiment are not limited to the illustration and can be changed, as appropriate. In addition, at least a part of the configurations described in the embodiment can be partially replaced or combined with each other.

### REFERENCE SIGNS LIST

1 . . . wireless communication system
20 . . . base station
30 . . . core network
101 . . . reception unit
102 . . . transmission unit
103 . . . control unit
201 . . . reception unit
202 . . . transmission unit
203 . . . control unit
11 . . . processor
12 . . . storage device
13 . . . communication device
14 . . . input-output device

What is claimed is:

1. A terminal comprising:
a reception unit configured to receive, from a base station, system information including first information and second information, the first information being used for configuring a first search space set for monitoring Physical Downlink Control Channel (PDCCH) candidates for first Downlink Control Information (DCI) including a Paging Early Indication (PEI), the second information being used for configuring a second search space set for monitoring PDCCH candidates for second DCI, the second DCI including information used for scheduling of a Physical Downlink Shared Channel (PDSCH) for a paging message and/or information used for indicating a short message; and
a control unit configured to control, in an idle state,
to monitor the PDCCH candidates for the first DCI on a primary cell based on the first information, to monitor the PDCCH candidates for the second DCI on the primary cell based on the second information, and to receive, from the base station, the paging message based on the information used for scheduling of the PDSCH included in the second DCI, wherein
the control unit is configured to control, in a connected state,
to monitor the PDCCH candidates for the second DCI on the primary cell based on the second information, and to receive, from the base station, the information used for indicating the short message included in the second DCI, and
the number of the PDCCH candidates in the first search space set per Control Channel Element (CCE) aggregation level is configured to be the same as the number of the PDCCH candidates in the second search space set per CCE aggregation level.

2. The terminal according to claim 1, wherein the control unit is configured to control, in the idle state, to receive, from the base station, the information used for indicating the short message included in the second DCI.

3. The terminal according to claim 1, wherein the control unit is configured to not monitor the PDCCH candidates for the first DCI in a case where the first information is not received.

4. The terminal according to claim 1, wherein Cyclic Redundancy Check (CRC) bits scrambled by a Paging Early Indication-Radio Network Temporary Identifier (PEI-RNTI) are attached to the first DCI.

5. The terminal according to claim 1, wherein CRC bits scrambled by a Paging RNTI (P-RNTI) are attached to the second DCI.

6. A base station comprising:
a transmission unit configured to transmit, to a terminal, system information including first information and second information, the first information being used for configuring a first search space set for monitoring Physical Downlink Control Channel (PDCCH) candidates for first Downlink Control Information (DCI) including a Paging Early Indication (PEI), the second information being used for configuring a second search space set for monitoring PDCCH candidates for second DCI, the second DCI including information used for scheduling of a Physical Downlink Shared Channel (PDSCH) for a paging message and/or information used for indicating a short message; and
a control unit configured to control, in a case where the terminal is in an idle state,
to transmit, to the terminal, the first DCI on a primary cell based on the first information, to transmit, to the terminal, the second DCI on the primary cell based on the second information, and to transmit, to the terminal, the paging message based on the information used for scheduling of the PDSCH included in the second DCI, wherein
the control unit is configured to control, in a case where the terminal is in a connected state,
to transmit, to the terminal, the second DCI including the information used for indicating the short message on the primary cell based on the second information, and
the number of the PDCCH candidates in the first search space set per Control Channel Element (CCE) aggregation level is configured to be the same as the number of the PDCCH candidates in the second search space set per CCE aggregation level.

7. The base station according to claim 6, wherein the control unit is configured to control, in the case where the terminal is in the idle state, to transmit, to the terminal, the second DCI including the information used for indicating the short message.

8. The base station according to claim 6, wherein the control unit is configured to control to not transmit, to the terminal, the first DCI in a case where the first information is not transmitted.

9. The base station according to claim 6, wherein Cyclic Redundancy Check (CRC) bits scrambled by a Paging Early Indication-Radio Network Temporary Identifier (PEI-RNTI) are attached to the first DCI.

10. The base station according to claim 6, wherein CRC bits scrambled by a Paging RNTI (P-RNTI) are attached to the second DCI.

11. A communication method of a terminal, comprising:
receiving, from a base station, system information including first information and second information, the first information being used for configuring a first search space set for monitoring Physical Downlink Control Channel (PDCCH) candidates for first Downlink Control Information (DCI) including a Paging Early Indication (PEI), the second information being used for configuring a second search space set for monitoring PDCCH candidates for second DCI, the second DCI including information used for scheduling of a Physical Downlink Shared Channel (PDSCH) for a paging message and/or information used for indicating a short message;
controlling, in an idle state, to monitor the PDCCH candidates for the first DCI on a primary cell based on the first information, to monitor the PDCCH candidates for the second DCI on the primary cell based on the second information, and to receive, from the base station, the paging message based on the information used for scheduling of the PDSCH included in the second DCI; and
controlling, in a connected state, to monitor the PDCCH candidates for the second DCI on the primary cell based on the second information, and to receive, from the base station, the information used for indicating the short message included in the second DCI, wherein
the number of the PDCCH candidates in the first search space set per Control Channel Element (CCE) aggregation level is configured to be the same as the number of the PDCCH candidates in the second search space set per CCE aggregation level.

12. The communication method according to claim 11, further comprising: controlling, in the idle state, to receive, from the base station, the information used for indicating the short message included in the second DCI.

13. The communication method according to claim 11, further comprising: controlling to not monitor the PDCCH candidates for the first DCI in a case where the first information is not received.

14. The communication method according to claim 11, wherein Cyclic Redundancy Check (CRC) bits scrambled by a Paging Early Indication-Radio Network Temporary Identifier (PEI-RNTI) are attached to the first DCI.

15. The communication method according to claim 11, wherein CRC bits scrambled by a Paging RNTI (P-RNTI) are attached to the second DCI.
